(19) United States
(12) Patent Application Publication
(10) Pub. No.: US 2026/0308020 A1
(43) Pub. Date: Oct. 8, 2026

(54) PHOTOTHERMAL POLYMERIC AEROGELS FOR WASTEWATER DETOXIFICATION AND WATER RECYCLING

(71) Applicant: University of Kentucky Research Foundation, Lexington, KY (US)

(72) Inventors: Mostafa Khodakarami, Lexington, KY (US); Rick Honaker, Nicholasville, KY (US)

(21) Appl. No.: 19/482,196

(22) PCT Filed: May 6, 2024
(86) PCT No.: PCT/US2024/027940

§ 371 Date: Nov. 6, 2025

Related U.S. Application Data
(60) Provisional application No. 63/465,150, filed on May 9, 2023.

(51) Int. Cl. C02F 1/28; B01J 20/12; B01J 20/20; B01J 20/24; B01J 20/26; B01J 20/28; B01J 20/30; C02F 101/10; C02F 101/30

(52) U.S. Cl. CPC C02F 1/288; B01J 20/12; B01J 20/205; B01J 20/24; B01J 20/262; B01J 20/267; B01J 20/28047; B01J 20/3085; B01J 2220/4806; B01J 2220/4825; C02F 2101/103; C02F 2101/308

(57) ABSTRACT

Aerogels, based on natural polymers with highly porous interconnected channels containing numerous functional groups having coordination capability with heavy metals for detoxification of wastewater generated by mining and metallurgical operations, are disclosed. Embodiments of the aerogels consist of biodegradable polysaccharides, modified to adjust water sorption capacity, and reinforced with inorganic nanostructures functionalized to be cross-linkable with polymers having light-absorption capacity. The light-to-heat conversion characteristic makes the aerogels applicable for recycling of wastewater in disposal pools using natural solar energy. This technology needs no or minimum energy input for water treatment and can be utilized for a wide range of operation scales, which makes it beneficial for small scale mining and metallurgical operations.

### RELATED APPLICATIONS

This application claims the benefit of U.S. Provisional Patent Application Ser. No. 63/465,150, filed May 9, 2023, the full disclosure of which is hereby incorporated by reference in its entirety.

### TECHNICAL FIELD

This document relates to chemical and material compositions and formulations to resolve mining and metallurgical toxic effluents. More particularly, this document relates to aerogels based on biodegradable/biocompatible polymers, functionalized and enforced by inorganic nanostructures and bio-inspired and/or synthetic photo-responsive polymers, for simultaneous detoxification and recycling of wastewaters disposed in disposal basins.

### BACKGROUND

The demand for critical minerals in the world is continuously increasing due to new emerging technologies and is expected to grow by 400 to 600% in the next few decades. Increasing production rate results in depletion of rich mineral sources and intensifying water-related challenges as mining and processing of minerals will require higher volume of water for producing per ton of minerals and metals. In addition to the challenges related to water shortage, there are other major concerns that need to be addressed.

While the mining industry is not a massive water consumer compared to the other sectors in national or global scale, water consumption by mining and mineral industry is densely clustered in regions which places more pressure on local communities, especially for those many mines located in arid and semi-arid areas. This has recently led to the opposition from local communities to new mining and mineral processing proposals based on water-related impacts.

In addition to depleting water supplies, the mineral industry produces a large volume of wastewater that can be harmful for the environment if discharged in an inappropriate way. According to the United States Geological Survey, 4 billion gallons of water was withdrawn from mining operations in U.S. in 2015. Water withdrawals from mining operations can cause serious problems such as acid mine drainage, processing chemicals pollution, heavy metal contamination as well as erosion and sedimentation. Highly acidic and some alkaline waters can be unhealthy to organisms in surface water. Acidic and alkaline waters can also dissolve metals previously adsorbed on surrounding rocks and minerals.

Although some trace metals are essential for biological life, they can be toxic for aquatic organisms in extremely high concentrations. Humans also can be affected by direct ingestion of contaminated water and by direct contact through outdoor activities such as swimming. All these adverse environmental effects make sustainable water and wastewater management critical for the mining and mineral industry. A part of the water used in mineral industry is reused in the process by recycling through conventional techniques such as filtration, precipitation, membranes, flocculation, and coagulation, however, there is a major amount of wastewater discarded in disposal basins to avoid them entering the environment.

Disposal basins are widely used to reduce the total volume of water that must be withdrawn, treated, and discharged. They are artificial ponds with very large surface areas that are designed to efficiently evaporate water by sunlight and avoid releasing mining wastewater effluents to the environment. To increase the evaporation rate, they are usually dyed bright blue to help absorb more sunlight and heat. Evaporation of water not only ignores the water recycling but also results in leaving extremely high concentrations of salts and heavy metals that can leach into the soil and pose severe impacts to the surrounding environment. It is essential to have novel and efficient technologies to treat wastewater discarded in disposal basins since the conventional technologies are not applicable or economically feasible to be used in disposal basins, as these techniques need a foundation of facilities and laborious operations.

### SUMMARY

In accordance with the purposes and benefits set forth herein, a new and improved photothermal polymeric aerogel is provided. That photothermal polymeric aerogel, comprises, consists of or consists essentially of an inorganic nanostructure and a polymer bound to the nanostructure. The polymer may be a natural polymer. The polymer may be a polysaccharide.

In at least some embodiments, the polymer is selected from a group of polymers consisting of chitosan, chitin, cellulose, carboxylated cellulose, hydroxyalkyl cellulose, alginates, alginic acid, guar gum, dextrin, pectin, and combinations thereof. In at least some embodiments, the polymer is selected from a group of polysaccharides, polymers with photothermal properties, and combinations thereof. The polymer with photothermal properties may be selected from polydopamine and conjugated polymers including polypyrrole, polyaniline, polythiophene, and combinations thereof.

The inorganic nanostructure may be a carbonaceous nanostructure. The inorganic nanostructure may be a clay-based nanostructure. The inorganic nanostructure may be a metal nanoparticle selected from transition and/or noble metals. The inorganic nanostructure may be made from a material selected from a group consisting of carbon nanotubes, graphene, halloysite nanotubes and combinations thereof.

In at least some embodiments, the polymer is polymerized to the nanostructure. In at least some embodiments, the inorganic nanostructures may be physically incorporated into the polymers via processes induced by Van der Waals forces, dipolar interactions or weak hydrogen bonding.

In some embodiments, the polysaccharide may be cross linked to the nanostructure with a cross-linking agent. The cross-linking agent may be selected from a group consisting of a multivalent ionic cross-linker including Ca²⁺ and Fe³⁺ complexes, carboxylic acids, inorganic acids, amides, glutaraldehyde, epoxy compounds, isocyanates and combinations thereof.

In some embodiments of the photothermal polymeric aerogel (a) the polymer is selected from a group of polymers consisting of chitosan, chitin, cellulose, carboxylated cellulose, hydroxyalkyl cellulose, alginates, alginic acid, guar gum, dextrin, pectin, polylactides, polyglycolide, poly(ε-caprolactone) , poly(trimethylene carbonate), and poly(p-dioxanone), polydopamine, polypyrrole, polyaniline, polythiophene and combinations thereof and (b) the inorganic nanostructure is made from a material selected from a group consisting of carbon nanomaterials including carbon nanotubes, graphene, clay-based nanostructures including halloysite nanotubes, nanoparticles composed of transition and/or noble metals, and combinations thereof.

The outer surface of the nanostructure may be hydroxylated prior to bonding with the polymer. The outer surface of the nanostructure may be carboxylated prior to bonding with the polymer. The outer surface of the nanostructure may be oxidated prior to bonding with the polymer. The outer surface of the nanostructure may be aminated/amidated prior to bonding with the polymer. In some of the many possible embodiments, one or more ligand shells are conjugated on the surface of the nanostructures. In some embodiments, some or more of the nanoparticles that are present are functionalized through a hybrid coating process involving encapsulation within a previously functionalized silica shell.

In accordance with an additional aspect, a photothermal polymeric aerogel comprises, consists of or consists essentially of an inorganic nanostructure having a functionalized outer surface and a polymer bound to the nanostructure. In accordance with still another aspect, a photothermal polymeric aerogel comprises, consists of or consists essentially of a functionalized inorganic nanostructure and a polymer bound to the nanostructure.

The polymer may be a polysaccharide. In at least some embodiments, the hydroxyl, carboxyl, and/or amino groups of polymers are physically and chemically modified to regulate the hydrophilicity/hydrophobicity of the aerogels. The hydrophobic segments may be saturated or unsaturated hydrocarbons including linear, branched, cyclic, and/or aromatic groups.

The natural polymers may be grafted to or cross-linked with other biocompatible synthetic molecules, monomers, oligomers, and polymers such as polylactide, polyglycolide, poly(ε-caprolactone) , poly(trimethylene carbonate), and poly(p-dioxanone).

In accordance with another aspect, a method of treating wastewater to remove toxic metals, comprises, consists of or consists essentially of contacting the wastewater with a photothermal polymeric aerogel as set forth in this document.

Still further, a method of making a photothermal polymeric aerogel, comprises, consists of or consists essentially of functionalizing an outer surface of a nanostructure and binding a modified polymer to the nanostructure.

The functionalizing may include carboxylating the outer surface. The functionalizing may include hydroxylating the outer surface. The functionalizing may include oxidization of the outer surface. In other embodiments, the functionalizing may include amidation/amination of the outer surface. The functionalizing may include conjugation of one or more ligand shells on the surface of the nanostructure. The functionalizing may include a hybrid coating process involving encapsulation of nanoparticles within a previously functionalized silica shell. Alternatively, the the functionalizing may include hydrophilic/hydrophobic regulation of the polymer backbone. The functionalizing may include grafting/crosslinking of a photothermal polymer to the polysaccharides. The functionalizing may include copolymerization of natural polymers with a synthetic biodegradable monomer, oligomer, and/or polymer.

Still further, in some embodiments, the method may include binding a modified polymer to the functionalized outer surface of the nanostructure. In some embodiments, a functional hybrid organic/inorganic structure is converted to aerogel through freeze-drying, or supercritical fluid, or ambient pressure techniques.

In the following description, there are shown and described several different embodiments of the new and improved (a) photothermal polymeric aerogel, (b) related method of treating wastewater with the photothermal polymeric aerogel, and (c) related method of making the photothermal polymeric aerogel. As it should be realized, the photothermal polymeric aerogels and related methods are capable of other, different embodiments and their several details are capable of modification in various, obvious aspects all without departing from the photothermal polymeric aerogels and methods as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate certain aspects of the photothermal polymeric aerogels and their methods of production and use and together with the description serve to explain certain principles thereof. A person of ordinary skill in the art will readily recognize from the following discussion that alternative embodiments of the photothermal polymeric aerogels and methods may be employed without departing from the principles described below.

FIG. 1 depicts a schematic of glutaraldehyde as a cross-linking agent bridging particles and polymers with hydroxyl and amino functional groups.

FIG. 2 illustrates a synthesis strategy for modifying chitosan with polylactic acid.

FIG. 3 demonstrates a synthesis strategy for modifying alginic acid with polydopamine.

FIG. 4 outlines the chitosan aerogel fabrication procedure.

FIG. 5 presents the carbon nanotube/chitosan aerogel fabrication procedure.

FIG. 6 illustrates the chitosan/polydopamine@carbon nanotube aerogel fabrication procedure.

FIG. 7 exhibits scanning electron microscope (SEM) images of (a) chitosan, (b) CNT/Ch, and (c) PDA@CNT/Ch aerogels.

FIG. 8 displays the Brunauer-Emmett-Teller (BET) surface area plot of the aerogels.

FIG. 9 showcases the Fourier transform infrared (FTIR) spectra of the aerogels.

FIG. 10 demonstrates the thermal gravimetric analysis (TGA) graphs of the aerogels.

FIG. 11 illustrates the x-ray photoelectron spectroscopy (XPS) survey of the aerogels.

FIG. 12 presents the water sorption capacity of the aerogels.

FIG. 13 explores the UV-Vis spectroscopy and light absorption performance of (a) Chitosan, (b) CNT/Ch, and (c) PDA@CNT/Ch.

FIG. 14 exhibits the effect of the initial As(V) concentration on the adsorption capacity of aerogels.

FIG. 15 illustrates the effect of contact time on the adsorption capacity of aerogels.

FIG. 16 displays the effect of pH on the adsorption capacity of aerogels.

FIG. 17 demonstrates the point of zero charge of aerogels.

FIG. 18 explores the effect of temperature on the adsorption capacity of aerogels.

FIG. 19 shows the FTIR spectra of aerogels before and after As(V) adsorption.

FIG. 20A presents high-resolution C1s spectra after peak differentiation and curve fitting for aerogels before and after As(V) adsorption.

FIG. 20B presents high-resolution O1s spectra after peak differentiation and curve fitting for aerogels before and after As(V) adsorption.

FIG. 20C presents high-resolution N1s spectra after peak differentiation and curve fitting for aerogels before and after As(V) adsorption.

FIG. 20D presents high-resolution differentiated As(V) peaks of aerogels after adsorption.

Reference will now be made in detail to the present preferred embodiments of the photothermal polymeric aerogels and related methods.

### DETAILED DESCRIPTION

One object of this document is to provide efficient materials for removal of heavy metals from mining and metallurgical wastewater. Another object is to functionalize materials with photothermal properties to recycle water through enhanced solar evaporation mechanisms. A still further object is to prepare materials that are composed of biodegradable/biocompatible polymers and more environmentally acceptable constituents.

Toward these ends, hybrid organic/inorganic aerogels with metal-coordination and light-to-heat conversion capabilities for simultaneous detoxification and recycling of wastewater generated by mining and metallurgical operations are disclosed. Photothermal polymeric aerogels may be broadly described as including one or more polymers and one or more inorganic nanostructures chemically bound or physically incorporated into the polymeric matrix.

The outer surface of the nanostructure may be modified to add functionalities including but not limited to hydroxyl (—OH), carboxyl (—COOH), amino (—NH₂), imino (═NH), epoxy (—COH—COH), ether (—COC—) and carbonyl (—C═O) prior to bonding to the polymer.

Depending on the environment and the ions and species present in the wastewater where the aerogel will be utilized, one or more ligand shells may be added to the surface of nanostructures. This enhances the adaptability and suitability of the nanostructures' exterior for further functionalization, tailored to the specific environment. The conjugation of ligands onto the nanostructures' surface can be accomplished through various chemisorption methods, including but not limited to Michael addition, amidation, imine formation, epoxide opening, and ring-opening metathesis reactions. Alternatively, nanoparticles can be functionalized through a hybrid coating process involving encapsulation within a previously functionalized silica shell, utilizing microemulsion techniques.

The polymer may be (a) polymerized directly to the surface of the nanostructure, (b) cross linked to the nanostructure by polysaccharide or other cross-linking agent or (c) bound to the nanostructure by both polymerization and cross linking.

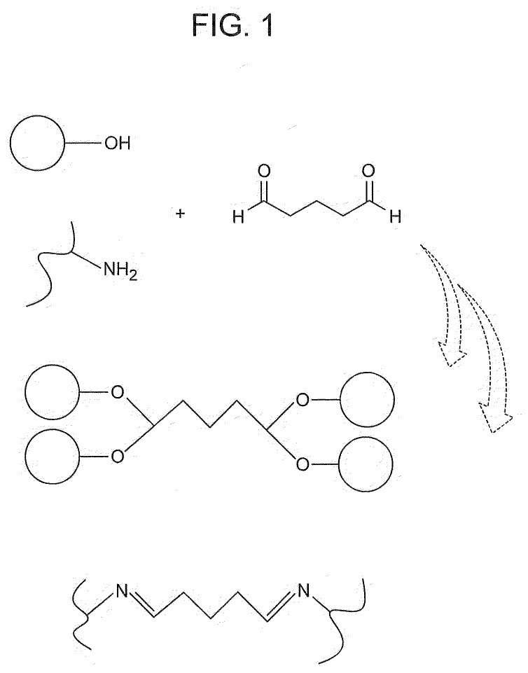

The cross-linking agent might be used to create bridges to introduce selected functionalities needed for wastewater detoxification and photothermal conversion, or for improving the mechanical and chemical stability of the polymeric component of the aerogels. The cross-linking agents of potential use include glutaraldehyde, epoxy compounds, and isocyanates (See FIG. 1).

The nanostructure may be physically incorporated into the polymers via processes induced by Van der Waals forces, dipolar interactions or weak hydrogen bonding, and encapsulated in polymers involving various procedures, known in the art, including physical adsorption, coacervation, and deposition by evaporation.

The photothermal polymeric aerogels may comprise carbonaceous and/or clay-based nanostructures such as carbon nanotubes and halloysite nanotubes, silica nanoparticles, and metal nanoparticles, with outer surface hydroxylated/carboxylated (in any manner known in the art), capable of bonding with polymeric components having different levels of hydrophilicity/hydrophobicity. The inorganic nanostructure may be of various types including multi-walled and single-walled nanotubes, sheets, rods, wires, and particles. The inorganic nanostructures might be employed for the purpose of providing selective metal-coordination capabilities, photothermal functionality, and/or improving the porosity, and chemical and physical durability of the aerogels.

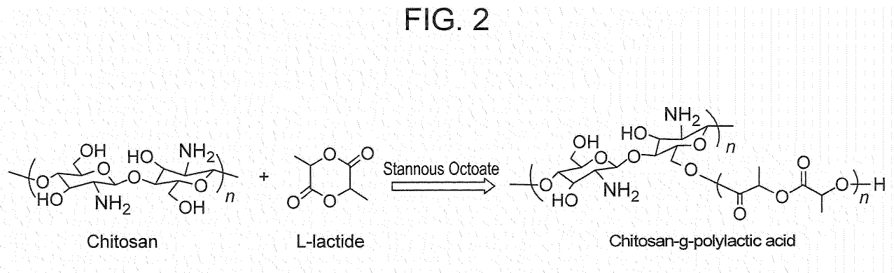

The biodegradable polymers might be natural polymers, mainly polysaccharides such as chitin, chitosan, cellulose, hemicellulose, carboxylated cellulose, hydroxyalkyl cellulose, alginates and alginic acid. The natural polymers may be grafted to or cross-linked with other biocompatible synthetic molecules, monomers, oligomers, and polymers such as polylactide, polyglycolide, poly(E-caprolactone), poly(trimethylene carbonate), and poly(p-dioxanone) (See FIG. 2). Synthetic polymers may be used to modify the pore characteristics and morphology of the aerogels, regulate the hydrophilic/hydrophobic properties, improve the mechanical strength and chemical resistance of the aerogels, and provide specific coordination chemistry.

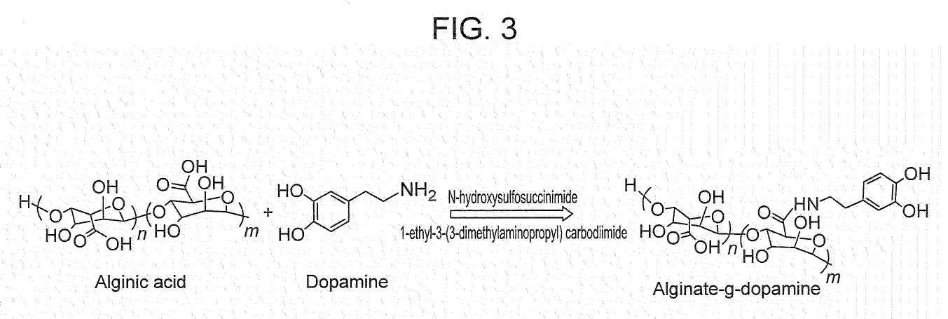

The photothermal properties of aerogels can be derived from the incorporation of various materials, including carbon nanomaterials like carbon nanotubes and graphene, metal nanoparticles composed of noble and/or transition metals, bio-inspired polymers such as polydopamine, and conjugated polymers like polypyrrole, polyaniline, polythiophene, and their derivatives. These materials can be grafted onto natural polymers or incorporated into inorganic nanostructures (See FIG. 3). Employing polydopamine and/or other conjugated polymers on carbon nanotubes, graphene, and photothermal metal nanoparticles result in a photothermal material with broad optical absorption over the visible and near-infrared field to improve photothermal properties of aerogels and powerfully enhance water evaporation of aerogels in sufficient and insufficient sunlight condition.

The aerogel can be obtained by freeze-drying technique through freezing the polymer-containing solution at temperatures between −10 to −40° C. followed by solvent removal through lyophilization in vacuum and temperatures below −100° C. In addition to the effect of compositional properties, the vacuum pressure, freezing rate, and solution viscosity can be controlled in freeze-drying technique to control the morphology of the aerogel structure.

In another approach, aerogels can be produced using the supercritical fluid technique, particularly when preserving the structure and minimizing shrinkage of the aerogel are significant concerns, or when impregnating active compounds during drying is important.

The solvents utilized in polymerization, grafting, copolymerization, cross-linking, structural modification reactions, and for dissolving and dispersing aerogel components can be either polar or non-polar, depending on the solubility properties of the reactants and agents. These solvents may be chosen from a range of options including aliphatic hydrocarbons, aromatic hydrocarbons, amines, esters, ethers, ketones, alcohols, as well as nitrated or chlorinated hydrocarbons.

Depending on the desired aerogel properties and the fabrication technique, the solvent might be selected from ionic liquids including imidazolium-, pyridinium-, and ammonium-based ionic liquids. In some aspects, one or more agents including but not limited to curing agents, radical initiators, dehydration agents, neutralizers, and phase modifiers may be used.

Photothermal polymeric aerogels may be used in the detoxification of mining and metallurgical wastewater with varying acidity level and comprised of heavy metals such as cadmium, chromium, lead, mercury, arsenic, etc. Still further, the technology can be used for treating acid mine drainage and in recovery of rare earth elements.

### EXPERIMENTAL EXAMPLES

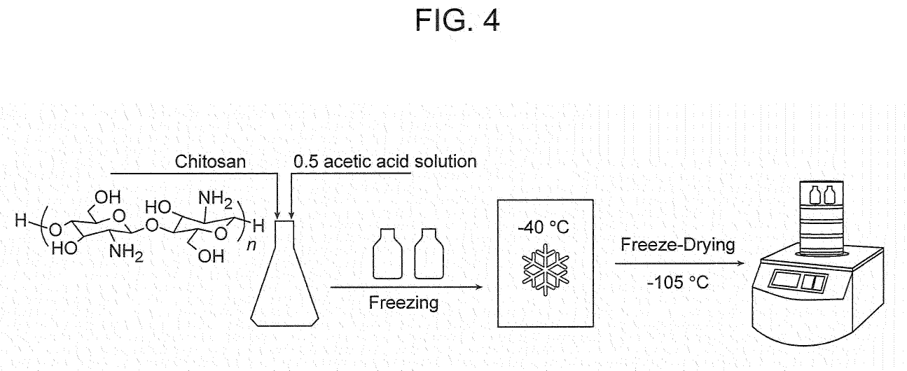

In one possible embodiment, chitosan with different concentration is dissolved in an aqueous solution with 0.25-2% v/v acetic acid at room or elevated temperature and stirred to form a transparent solution. The resulting chitosan solution is frozen at −40° C. and then lyophilized at −105° C. for 24-48 hours to obtain a chitosan aerogel (See FIG. 4).

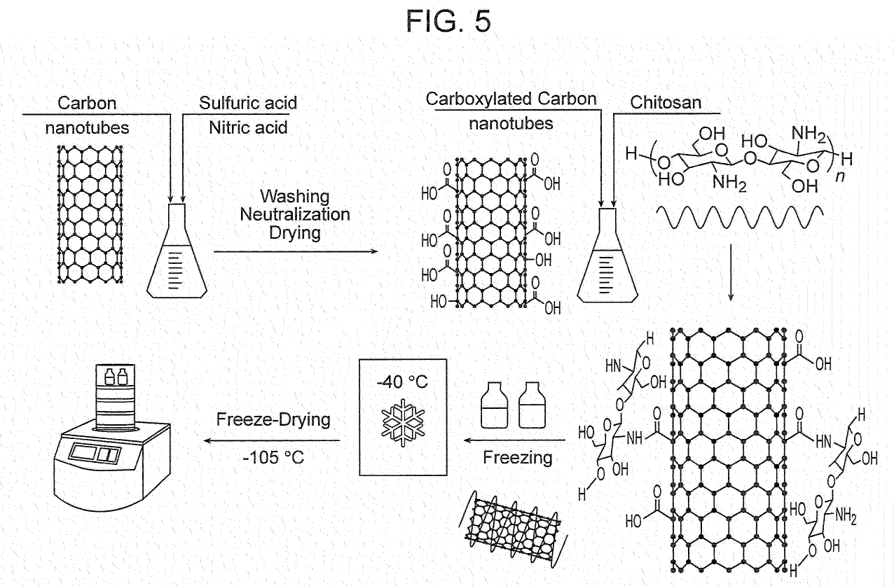

In one possible embodiment, chitosan aerogel is modified with carbon nanotubes (See FIG. 5). A certain amount of carbon nanotubes is carboxylated using a mixture of sulfuric acid and nitric acid at room temperature. The carboxylated carbon nanotubes are neutralized with deionized water until the pH is ~7. Carboxylation of carbon nanotubes improves their dispersibility in aqueous environment and provides cross linking sites. Carboxylated carbon nanotubes are filtered and dried in vacuum, then dispersed by sonication in an aqueous solution (0.25-2 % v/v% acetic acid) containing chitosan and stirred at 40-60° C. 6-8 hours. The resulting solution is frozen at −40° C. and then freeze-dried at −105° C. for 24-48 hours to produce the photothermal polymeric aerogel.

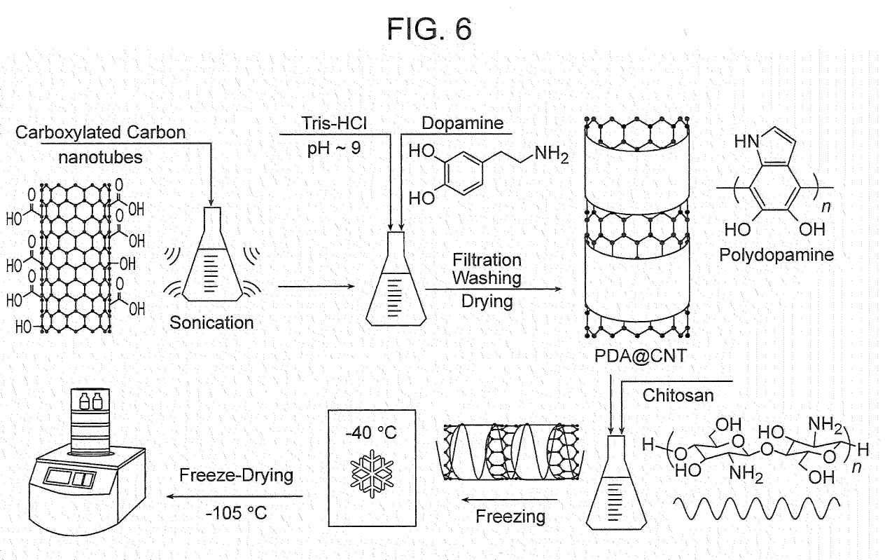

In yet another possible embodiment, the carbon nanotube/chitosan aerogel is modified with polydopamine via the procedure shown in FIG. 6. A certain amount of carboxylated carbon nanotubes is dispersed in tris buffer (10 mM, pH~9) aqueous solution via sonication for 30 min, then the dopamine is slowly added to the solution and mixed for 24 hours at ambient temperature. The resulting solution is filtered and washed with deionized water until the filtrate becomes colorless. The obtained polydopamine@carbon nanotube is then dried overnight in a vacuum oven at 60° C. A certain amount of polydopamine@carbon nanotube is dispersed in a chitosan-containing solution by sonicating for 30 minutes and then mixed at 50° C. for 8 hours. The resulting solution is frozen overnight at −40° C. and then freeze-dried at −105° C. for 48 hours to obtain chitosan/polydopamine@carbon nanotube aerogels.

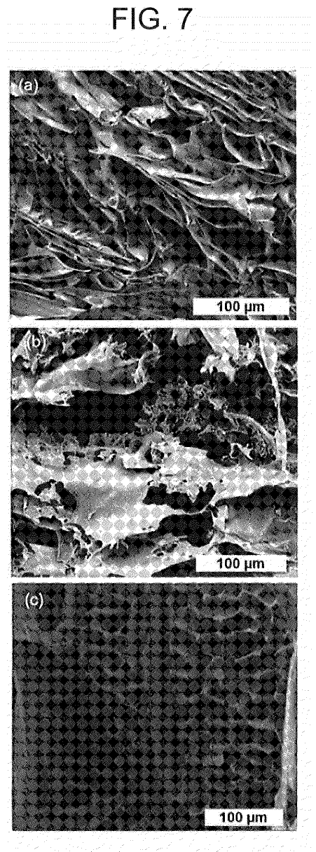

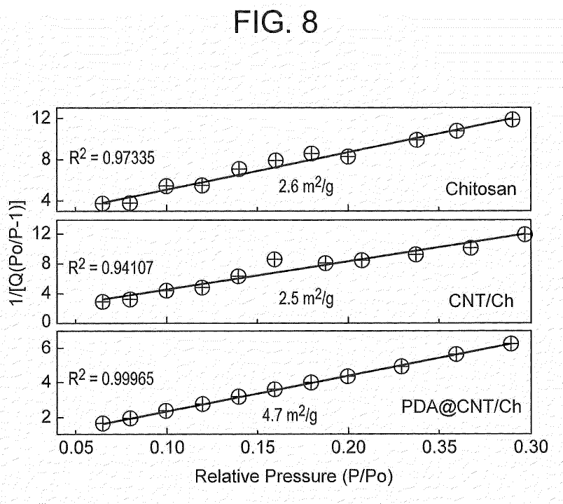

The chitosan aerogel displayed a smooth, closely contacted lamellar network structure with a lamella thickness of approximately 1 μm and an interlayer spacing of less than 20 μm. The incorporation of carbon nanotubes disrupted the laminar sheet-like morphology of the chitosan aerogels, resulting in the formation of small pores and wrinkles on the laminar sheets. This led to an increase in the surface roughness and formation of a fibrous microstructure of the chitosan aerogels. The incorporation of polydopamine into the CNT/Ch aerogel resulted in higher porosity with a cellular structure between lamellar sheets and cell dimensions ranging from 5 to 50 μm (See FIG. 7). According to BET surface area analysis (See FIG. 8), the specific surface area of the chitosan aerogel was 2.62 m²/g, while the incorporation of carbon nanotubes slightly decreased the surface area to 2.54 m²/g, probably due to the partial agglomeration of CNT particles, as evidenced by morphological analysis.

Decreasing the CNT content can lower CNT agglomeration, and an increase in the specific surface area is expected with decreasing CNT content of the aerogel. However, according to the pore volume analysis, the pore volume of the CNT/Ch aerogel was much smaller than that of the chitosan aerogel (0.019 vs. 0.0014 cm³/g), indicating a larger number of pores in CNT/Ch compared to the chitosan aerogel, considering the similar surface area of these aerogels. The incorporation of polydopamine nearly doubled the specific surface area to 4.71 m²/g and slightly increased the pore volume to 0.02 7cm³/g through the formation of a uniform cellular structure and preventing the agglomeration of CNTs.

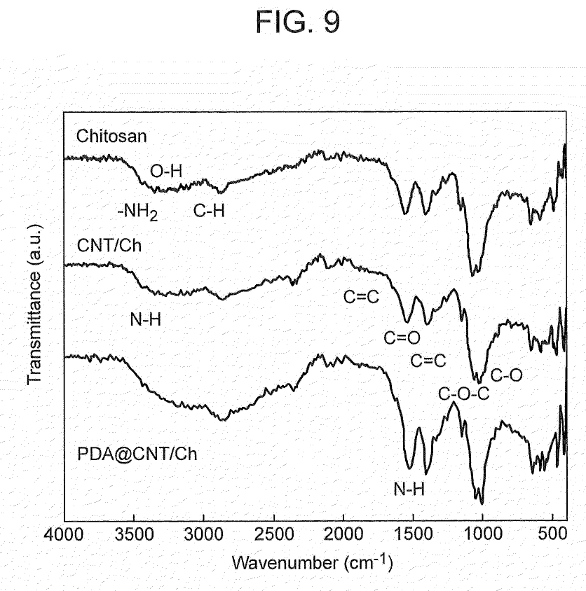

As shown in FTIR spectra of the aerogels (See FIG. 9), the broad band observed at 3100-3500 cm⁻¹ corresponds to the stacking of —OH and —NH₂ stretching vibrations, whereas the bands at 2808-2950 cm⁻¹ correspond to the C—H stretching of hydrocarbons in chitosan. The peaks detected at 1558 and 1408 cm⁻¹ in the FTIR spectrum of chitosan can be attributed to the stretching vibrations of the asymmetric and symmetric-COOH functional groups, respectively. The bands at 1026 and 1068 cm⁻¹ in the chitosan spectrum can be ascribed to the stretching vibrations of C—O and C—O—C, respectively. For CNT/Ch, the peaks detected at 1381 and 1539 cm⁻¹ correspond to the stretching vibrations of C—C and C═O, respectively. Moreover, the peaks observed at 1558, 1408, 1153, 1068, and 1028 cm⁻¹ in the chitosan spectrum shifted to 1543, 1404, 1149, 1064, and 1018 cm⁻¹, respectively, suggesting interactions between chitosan and carbon nanotubes, including hydrogen bonding between the —COOH groups of carbon nanotubes and —NH₂ groups of chitosan. In the case of the PDA@CNT/Ch aerogel, the absorption band at 3000-3500 cm⁻¹ was stronger than that in the chitosan and CNT/Ch aerogels, indicating the presence of more amine and hydroxyl groups as well as hydrogen-bond interactions in the PDA@CNT/Ch aerogel. Furthermore, the peaks related to the vibration of N—H bonding (1319 cm⁻¹) of CNT/Ch, —NH₂ and —OH stretching vibrations (3348 cm⁻¹) as well as the —NH₂ bending vibration (1334 cm⁻¹) of chitosan shifted to 1300 cm⁻¹, 3209 cm⁻¹, and 1330 cm⁻¹, respectively, indicating the formation of hydrogen bonding between PDA@CNT and chitosan.

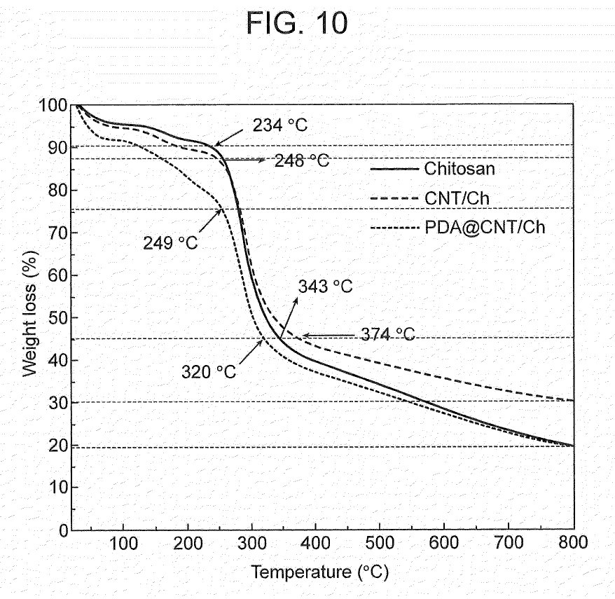

As evident by TGA analysis (See FIG. 10), the initial weight loss observed below 100° C. for all samples corresponded to the loss of moisture. The second degradation for the chitosan, CNT/Ch, and PDA@CNT/Ch aerogels started at approximately 140, 120, and 108° C., respectively, and continued until 234, 248, and 249° C., with weight losses of ~10, 13, and 23%, respectively. In the second weight loss stage, PDA@CNT/Ch appeared to have higher weight loss, which could be attributed to the potential decomposition of excessive hydroxyl groups. The CNT/Ch aerogel exhibited higher thermal stability than the other aerogels, losing 55% of its weight at 374° C., whereas the chitosan and PDA@CNT/Ch aerogels lost the same amount of weight at 343 and 320° C., respectively. The fourth stage of degradation continued until 800° C., with overall weight losses of approximately 80, 70, and 80% for chitosan, CNT/Ch, and PDA@CNT/Ch, respectively.

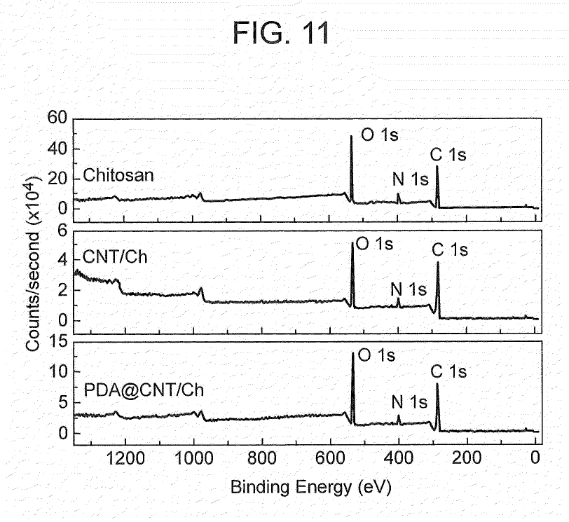

The XPS surveys (See FIG. 11) show three characteristic peaks of C1s, N1s, and O1s for all aerogels. The carbon content of chitosan increased upon modification by carbon nanotubes, which resulted in 2.4 times reduction in the N/C ratio, while the O/C ratio decreased only 1.5 times, due to the presence of hydroxyl and carboxyl groups on the CNTs. Upon modification of CNT/Ch by polydopamine, the carbon content of aerogel decreased from 71.56% to 62.33%, while the N/C and O/C ratio increased from 0.05 and 0.34 to 0.11 and 0.49, respectively, revealing the modification of CNT surface by polydopamine.

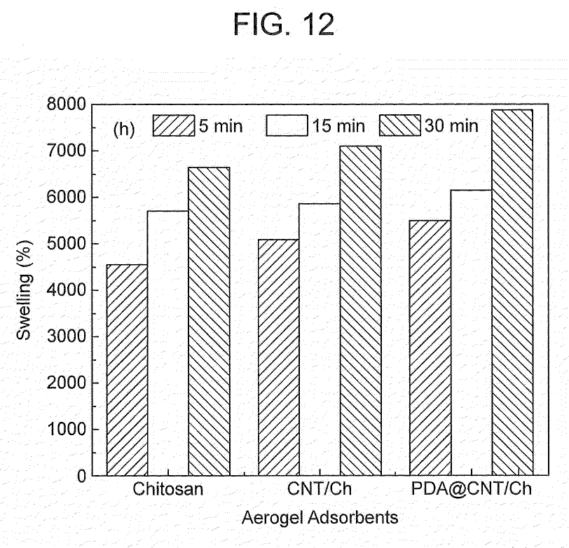

All aerogels underwent rapid swelling within the first 5 min of immersion in water, reaching sorption capacities of 45.5, 57.2, and 66.3 g/g for chitosan, CNT/Ch, and PDA@CNT/Ch aerogels, respectively (See FIG. 12). When the immersion time was prolonged to 30 min, the water sorption capacities of chitosan, CNT/Ch, and PDA@CNT/Ch reached 54.7, 61, and 78.4 g/g, respectively. The water sorption capacity of the aerogels increased in the order of chitosan<CNT/Ch<PDA@CNT/Ch, depending on the amount of readily available —OH and —NH groups.

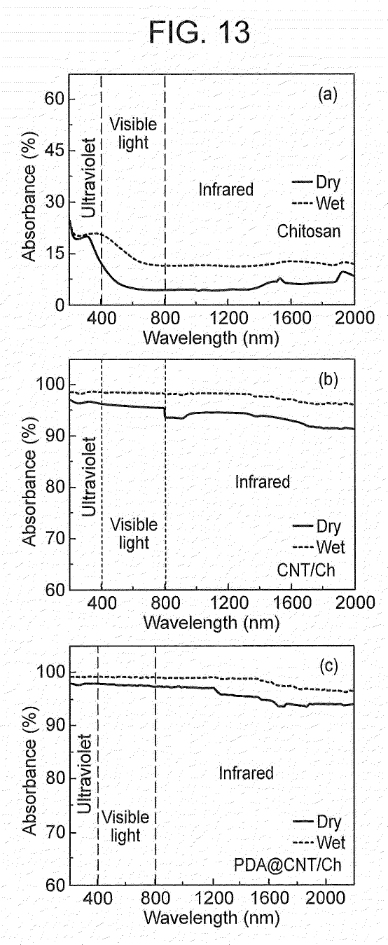

As shown in UV-Vis spectra of the aerogels (See FIG. 13), the chitosan aerogel demonstrated limited light absorption, reflecting almost 90-95% of light in the infrared region, while displaying higher light absorption in the visible and ultraviolet regions (<600 nm). The light absorption by chitosan aerogel is likely attributable to its microporous structure, which results in scattering of light inside the aerogel. The CNT/Ch aerogel displayed strong light absorption, absorbing ~90-92% in the infrared range and ~94-97% in the visible range of the spectrum. As displayed in FIG. 13, functionalization of the CNT/Ch aerogel with polydopamine resulted in stronger light absorption properties in a broader range of spectra including infrared, visible, and ultraviolet regions (~94-98%). The higher light absorption efficiency of the PDA@CNT/Ch aerogel might be attributed to the broad optical absorption capability of polydopamine and the higher porosity of PDA@CNT/Ch, which results in lower light reflectance due to internal light scattering. Light absorption increased by 2-4% for all aerogels when wetted with deionized water. The wet CNT/Ch and PDA@CNT/Ch aerogels absorbed ~98-99% of the light in visible region (400-800 nm). The higher light absorption of the wet aerogels can be ascribed to the higher bending ability of light when meeting the water film on the wet aerogels, which results in lower light reflection and higher scattering of light inside their porous structure.

As demonstrated by the infrared camera images (not shown) of the aerogel surfaces under illumination in the near-infrared range of the spectrum (760 nm), the surface temperature of the chitosan aerogel rose to ~28° C., showing no significant photothermal properties, while the surface temperature of the CNT/Ch aerogel rapidly increased to ~100° C. after ~5 min and then remained constant over time, indicating the rapid photothermal conversion ability of the chitosan aerogels after modification by carbon nanotubes. This can be ascribed to the T-electron system of carbon nanotubes, which absorbs photons, leading to the excitation of electrons within the structure of nanotubes and rapid energy transfer through non-radiative processes. The PDA@CNT/Ch aerogel exhibited high photothermal conversion properties, reaching ~130° C. after ~5 min of exposure to light, attributed to polydopamine modification, which has a higher antireflection structure, resulting in more light absorption in the near-infrared range of the spectrum. The higher number of pores in the CNT/Ch and PDA@CNT/Ch aerogels can also contribute to higher light-to-heat conversion by reducing surface reflection and increasing internal light scattering.

The fabricated aerogels may be used for removal of organic pollutants, such as dyes, and inorganic contaminants, such as arsenic, from an aqueous solution (of the type found in disposal ponds at mining and metallurgical operation sites) with different pH values.

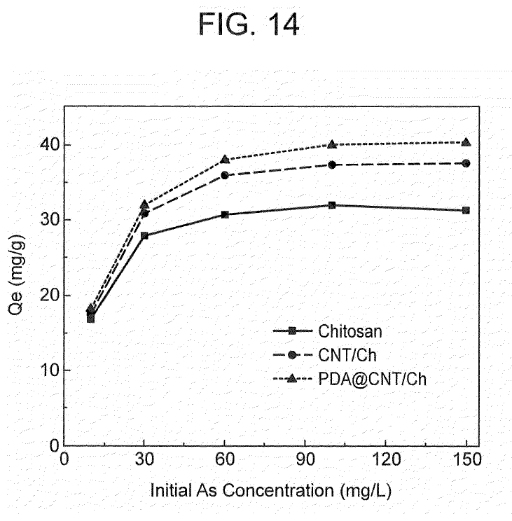

The example aerogels were tested for removal of arsenic from water. The results demonstrated a direct relationship between the adsorption capacity and the initial As(V) concentration (See FIG. 14). For example, at an initial concentration of 150 mg/L, the adsorption capacity of the chitosan aerogel was 31.4 mg/g, which was 1.9 times higher than the value observed at an initial concentration of 10 mg/L (16.96 mg/g). The increase in adsorption capacity at higher initial concentrations can be attributed to the larger concentration gradient and stronger driving force for ion transfer, allowing more As(V) ions to come into contact with the surface of the aerogels, facilitating enhanced adsorption. The adsorption capacities of the CNT/Ch and PDA@CNT/Ch aerogels at 10 mg/L were 17.6, and 18.2 mg/g, respectively, which rose to ~36 and 38 mg/g, respectively, when the initial As(V) concentration increased to 60 mg/g, demonstrating the higher efficiency of the chitosan aerogel when modified by carbon nanotubes and polydopamine. As the initial As(V) concentration increased to 150 mg/L, the adsorption capacities of the chitosan, CNT/Ch, and PDA@CNT/Ch aerogels slightly increased to 31.4, 37.6 and 40.3 mg/g, respectively. The addition of CNT and PDA seems to be favorable for As(V) sorption, probably due to the introduction of-COOH groups of carbon nanotubes in CNT/Ch and the formation of a well-developed porous structure in the PDA@CNT/CH aerogels. The performance of aerogels depends on a combination of the main factors, including porosity and surface area, as well as the density of functional groups with an affinity toward arsenic ions. An optimal matching between the surface area and density of the functional groups on the aerogels is anticipated to yield a high adsorption capacity.

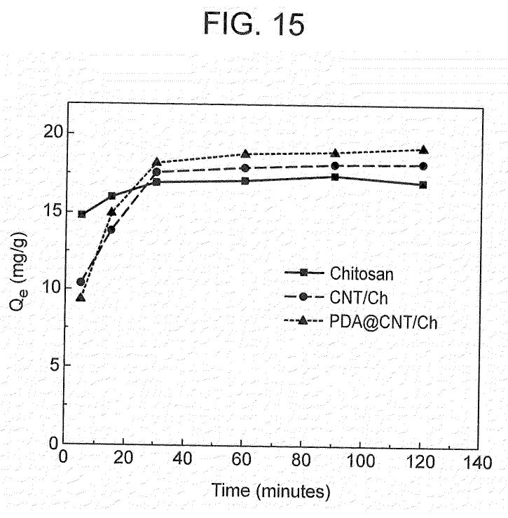

The adsorption rates of the aerogels were initially very high within the first 15 min and then slowly increased to their equilibrium value after approximately 30-90 minutes (See FIG. 15). The adsorption capacities of chitosan, CNT/Ch, and PDA@CNT/Ch aerogels reached 14.8, 10.4, and 9.4 mg/g in the first 5 min and then rapidly increased to 15.9, 13.8, and 15.1 mg/g in the next 10 minutes, which accounted for 90, 74, and 77 % of the equilibrium adsorption capacity of chitosan, CNT/Ch, and PDA@CNT/Ch aerogels, respectively. The initial rapid rate can be attributed to the abundance of available adsorbent sites during the early stages, enabling a higher rate of adsorption for arsenic ions. Conversely, the subsequent decline in rate can be ascribed to the reduction in the number of vacant active sites and the decrease in arsenic concentration as the contact time increased. Additionally, the resistance encountered during mass transfer into the aerogels' pores upon increasing time possibly contributed to the adsorption rate reduction.

As evident in FIG. 15, the chitosan aerogel exhibited a higher adsorption capacity during the first 15 min, whereas the adsorption capacity of the CNT/Ch and PDA@CNT/Ch aerogels exceeded that of chitosan after 30 min. This implies that a single mechanism may not be sufficient to explain the adsorption process, and that the modified chitosan aerogels may have different rate-limiting mechanisms.

Based on intraparticle diffusion model, in addition to the intraparticle diffusion process, the formation of a boundary water layer and film diffusion might be the rate-determining mechanisms. The fitting of kinetic data to the intraparticle diffusion model suggests three distinct adsorption stages for all aerogels. In the first stage, chitosan showed faster adsorption, probably due to its looser structure in water, resulting in a higher accessible surface for external mass transfer. In the second stage, the CNT/Ch and PDA@CNT/Ch aerogels exhibited steeper slopes and reached a higher amount of adsorption, demonstrating a more pronounced intraparticle diffusion-controlled adsorption process and higher efficiency in accommodating arsenic ions in the porous structure. Once the intraparticle diffusion reached the point of equilibrium, the adsorption process entered the third stage, at which point the plot showed a plateau, and the arsenic uptake remained relatively constant.

The chemistry of ions in water is largely determined by the Eh-pH conditions, which subsequently dictate the bonding and adsorption mechanisms of the ions. Arsenic is typically found in water in four oxidation states (—3, 0, +3, and +5), with the prevalent forms being arsenite (As(III)) and arsenates (As(V)). The species of As(V) present in water are H₂AsO₄⁻ in the pH range of ~2.2-6.7, and HASO₄²⁻ in the pH range of 6.7-11.5. Below pH 2.2, the major species of As(V) are uncharged in the form of H₃AsO₄, while above pH 11.5 AsO₄³⁻ is dominant. Below pH 9.2, As(III) is commonly found in an uncharged form, such as H₃AsO₃, while at pH value greater than 9.2, As(III) transforms into negatively charged species, including H₂AsO₃⁻, HASO₃²⁻, and AsO₃³⁻. Although both arsenite and arsenate might be present in water, arsenates are more common in aerated and oxidization environments.

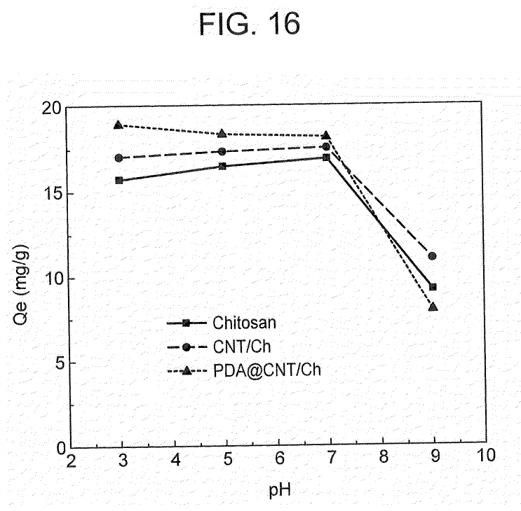

The adsorption capacity of all aerogels was higher in an acidic environment (pH≤7). The maximum adsorption capacity of PDA@CNT/Ch occurred at pH 3 and slowly decreased from 19.3 to 18.2 mg/g as the pH increased from 3 to 7 (See FIG. 16). The Adsorption capacities of the chitosan and CNT/Ch aerogels remained almost constant under acidic conditions, with slight increase from 15.8 and 17.12 to 16.96 and 17.6, respectively. The high performance of the aerogels at pH≤7 is probably attributed to the surface protonation of the aerogels, whereby the protonation of amino groups could be more active under acidic conditions, resulting in a highly positive charge on the surface. This phenomenon resulted in a higher adsorption capacity of PDA@CNT/Ch at low pH values because of the presence of more amino groups on the surface. This is further confirmed by investigating the surface charge of the aerogels in acidic and alkaline environments.

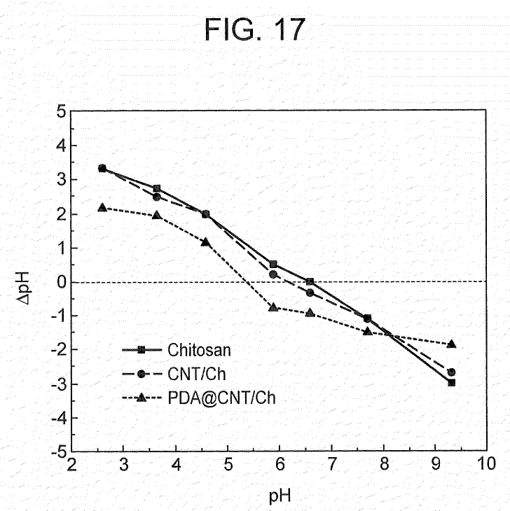

As depicted in FIG. 17, the surface charge of the aerogels changed from positive to negative with the increase of pH, and the point of zero charge for Chitosan, CNT/Ch, and PDA@CNT/Ch aerogels appeared to be at about 6.6, 6.3, and 5.4, respectively. Additionally, since As(V) ions are primarily present in the form of H₂AsO₄⁻ ions with low free adsorption energy in the pH range of 3-6.5, the strong electrostatic interaction between the positively charged aerogels and negatively charged As(V) ions facilitates adsorption, leading to a higher adsorption capacity of the aerogels. The hydroxyl and amino groups in aerogels tend to be deprotonated with increasing pH to 9, resulting in electrostatic repulsion of the aerogels and electronegative As(V) ions in the form of HASO₄²⁻, which caused the adsorption capacity to gradually decrease from 16.96, 17.6, and 18.2 mg/g to 9.2, 11, and 8.1 mg/g for chitosan, CNT/Ch, and PDA@CNT/Ch aerogels, respectively. The lower adsorption capacity of the aerogels at higher pH levels might also be due to the competition between OH and HASO₄²⁻ for positively charged adsorption sites.

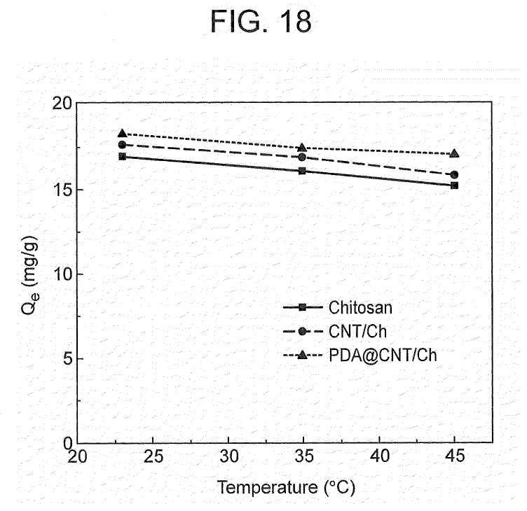

FIG. 18 illustrates that the adsorption capacity of aerogels is almost independent of temperature, showing a slight decrease from 16.96, 17.6, and 18.2 mg/g to 15.2, 15.8, and 17.1 mg/g for chitosan, CNT/Ch, and PDA@CNT/Ch aerogels, respectively as the temperature increased from room temperature to 45° C. The independence of the aerogel adsorption capacity from temperature supports the chemisorption of As(V) ions by the aerogels, and the slight decrease in the adsorption capacity might be due to the tendency of physisorbed As(V) ions to desorb from the surface of the aerogels at higher temperatures, influenced by the unique speciation of As(V) ions in water. However, prior investigations have indicated that for contaminants with different ionic speciation and forming cationic species in water (e.g., Pb(II), Cu(II), and U(VI)), chitosan—acting as the foundational material for the example aerogels—exhibits improved performance at elevated temperatures compared to lower temperatures.

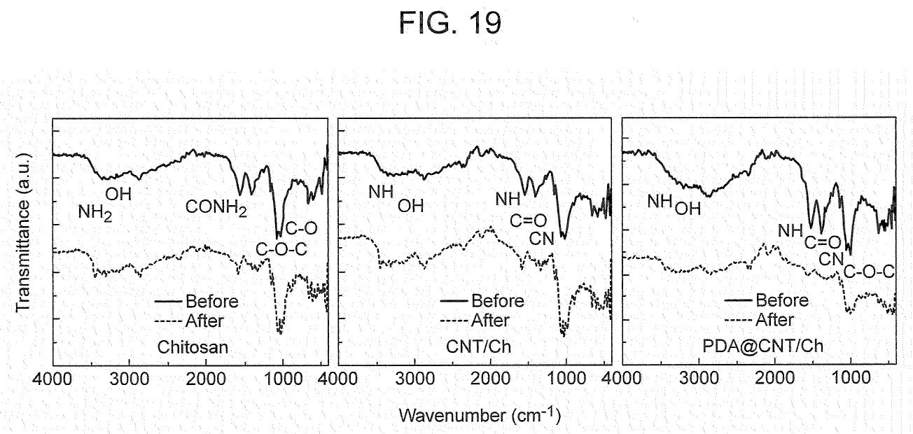

As shown by the FTIR spectra of aerogels before and after As(V) adsorption (See FIG. 19), sharper peaks appeared at 3000-3600 cm⁻¹ after As(v) adsorption by chitosan and CNT/Ch aerogels, revealing the participation of amino and hydroxyl groups of aerogels. The C═O and NH groups of all aerogels participated in the adsorption of As(V) ions as the intensity of the relative characteristic peaks significantly changed after adsorption. In the case of PDA@CNT/Ch, the peaks related to C—O—C groups were weakened after As(V) adsorption, indicating the interaction of arsenic ions with C—O—C groups. The participation of various functional groups of aerogels in the adsorption process indicates the presence of multiple mechanisms in removal of As(V) ions, such as physical electrostatic interactions, chelation, and chemisorption.

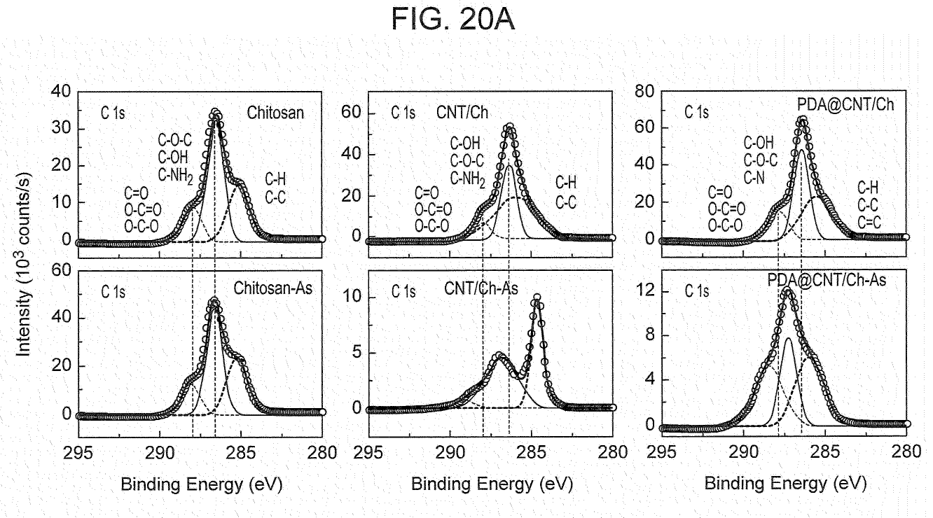

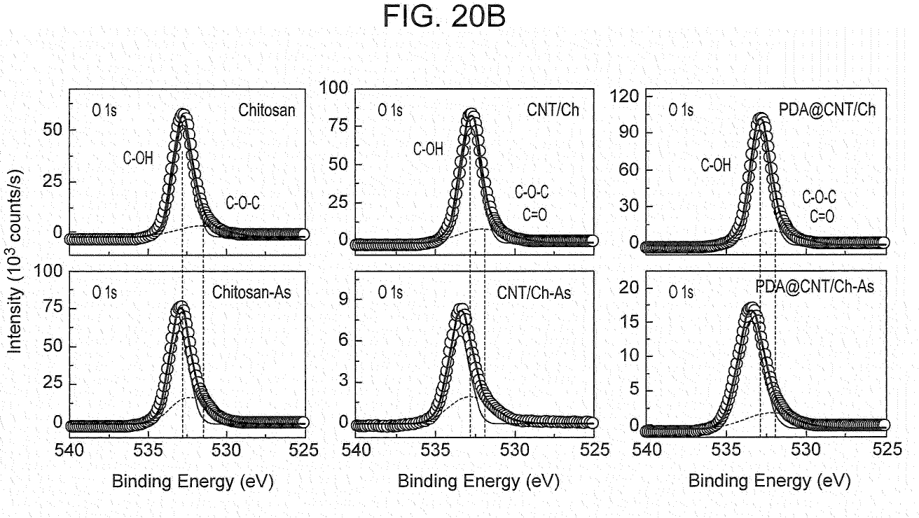

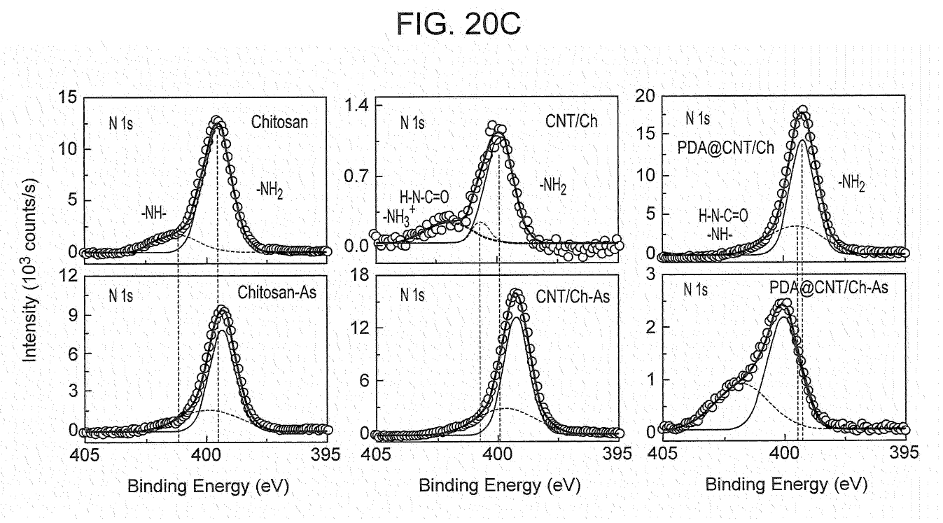

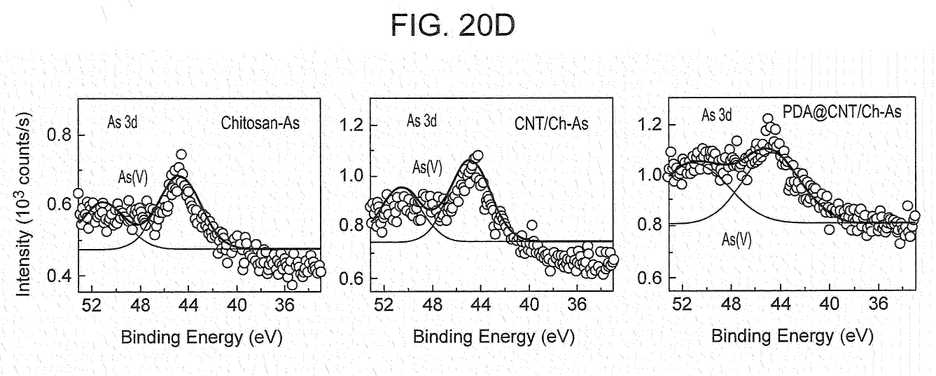

The high-resolution C1s, N1s and O1s XPS spectra of aerogels, differentiated and curve-fitted with a regression coefficient (R²)>0.99, are presented in FIG. 20A-20D. The C1s spectra revealed the presence of various groups including C—C, C—H, C—O, C—O—C, C—NH₂, C—OH, C═O, O—C—O and O—C═O in aerogels (FIG. 20A). FIG. 20B shows the splitting of the O1s spectra of aerogels into two peaks attributed to C—OH and C—O—C/C═O groups with corresponding binding energies of 533 and 532.4 eV for chitosan, 533.3 and 532.8 eV for CNT/Ch, and 533.5 and 532.3 eV for PDA@CNT/Ch, respectively. The N1s spectra of the aerogels were processed through peak differentiation and curve-fitting, revealing the splitting of the N1s peak into two peaks attributed to —NH— and —NH₂ groups with corresponding binding energies of 401.2 and 399.6 eV for chitosan, and 401.8 and 400.4 eV for PDA@CNT/Ch, respectively. In the case of CNT/Ch, an extra broad peak was detected with corresponding binding energy of 402 eV, probably attributed to the protonation of amino groups in chitosan after modification with carbon nanotubes. Two other peaks attributed to —NH— and —NH₂ groups were found at binding energies of 400.8 and 399.8 eV, respectively.

The O—C═O/C═O groups of CNT/Ch aerogel experienced a higher increase of binding energy after As(V) adsorption, indicating greater role of carboxylate groups of carbon nanotubes in coordination with As(V) ions compared to —NH— groups. This is confirmed by O1s, where both peaks shifted to higher binding energies, while the binding energies corresponding to the —NH— and —NH₂ peaks both decreased in N1s spectra of CNT/Ch. In the case of PDA@CNT/Ch, a strong shift was observed for both of the peaks in C1s spectra, indicating that, in addition to O—C═O/C═O groups, —NH—/—NH₂ groups also played major role in As(V) adsorption by PDA@CNT/Ch aerogel. This is confirmed by the Ns spectra of PDA@CNT/Ch. As evident in FIG. 20A-20D, the increase of binding energy corresponding to —NH— was greater than that of —NH₂, probably due to the contribution of —NH— groups of polydopamine in As(V) adsorption. In the case of chitosan aerogel, although the peak corresponding to the C—OH/C—O—C groups in C1s spectra did not shift significantly, the intensity of this peak increased by ~37%, indicating that these groups played role in As(V) adsorption. Considering the O1s spectra of chitosan, the C—O—C group also experienced large binding energy increase, probably implying that C—O—C groups of chitosan rings also contributed to the coordination with As(V) ions. The adsorption of As(V) ions resulted in the emergence of As(V) peaks with corresponding binding energies between 44 and 51 mV on aerogels, with the highest intensity for PDA@CNT/Ch, which aligns with the findings obtained from the adsorption experiments.

This document relates to technology for the treatment of wastewater disposed in evaporation ponds that are currently not considered for the treatment. The ultra-low density composite material, abundant with functional groups, and the photothermal functionality incorporated into the surface of the materials enable this technology not only to detoxify the wastewater in evaporation ponds but also provide a platform that can recycle water using solar energy and through an accelerated evaporation mechanism. This eliminates the necessity for a continuously operating wastewater treatment facility. As described in various embodiments, this technology provides a “platform” capable of accommodating diverse task-specific functionalities tailored to the properties and composition of the wastewater. Examples are: creation of hydrophobic-hydrophilic gradient across the aerogel platforms through carboxy-alkylation of the hydroxyl and/or amine groups of the natural polymers for the regulation of water sorption capacity; mitigating the mechanical integrity issues of natural polymer-based aerogels in contact with water by modifying them with synthetic biodegradable polymers; and incorporation of an intermediate ligand shell onto the surface of inorganic nanostructures to enhance adaptability and suitability of the nanostructures' exterior for further functionalization, tailored to specific environments.

It may be said that this document relates to the following items.
1. A photothermal polymeric aerogel, comprising:
   an inorganic nanostructure; and
   a polymer bound to the nanostructure.
2. The photothermal polymeric aerogel of item 1, wherein the polymer is a natural polymer.
3. The photothermal polymeric aerogel of item 2, wherein the polymer is a polysaccharide.
4. The photothermal polymeric aerogel of item 2, wherein the polymer is selected from a group of polymers consisting of chitosan, chitin, cellulose, carboxylated cellulose, hydroxyalkyl cellulose, alginates, alginic acid, guar gum, dextrin, pectin, and combinations thereof.
5. The photothermal polymeric aerogel of item 1, wherein the polymer is selected from a group of a polysaccharide, a polymer with photothermal properties, and combinations thereof.
6. The photothermal polymeric aerogel of item 5, wherein the polymer with photothermal properties may be selected from polydopamine and conjugated polymers including polypyrrole, polyaniline, polythiophene, and combinations thereof.
7. The photothermal polymeric aerogel of item 1, wherein the inorganic nanostructure is a carbonaceous nanostructure.
8. The photothermal polymeric aerogel of item 1, wherein the inorganic nanostructure is a clay-based nanostructure.
9. The photothermal polymeric aerogel of item 1, wherein the inorganic nanostructure is a metal nanoparticle selected from transition and/or noble metals.
10. The photothermal polymeric aerogel of item 1, wherein the inorganic nanostructure is made from a material selected from a group consisting of carbon nanotubes, graphene, halloysite nanotubes and combinations thereof.
11. The photothermal polymeric aerogel of item 1, wherein the polymer is polymerized to the nanostructure.
12. The photothermal polymeric aerogel of item 1, wherein the inorganic nanostructures may be physically incorporated into the polymers via processes induced by Van der Waals forces, dipolar interactions or weak hydrogen bonding.
13. The photothermal polymeric aerogel of item 1, wherein the polysaccharide is cross linked to the nanostructure with a cross-linking agent.
14. The photothermal polymeric aerogel of item 16, wherein the cross-linking agent is selected from a group consisting of a multivalent ionic cross-linker including Ca²⁺ and Fe³⁺ complexes, a carboxylic acid, an inorganic acid, an amide, a glutaraldehyde, an epoxy compound, an isocyanate and combinations thereof.
15. The photothermal polymeric aerogel of item 1, wherein (a) the polymer is selected from a group of polymers consisting of chitosan, chitin, cellulose, carboxylated cellulose, hydroxyalkyl cellulose, an alginate, alginic acid, guar gum, dextrin, pectin, a polylactide, polyglycolide, poly(8-caprolactone), poly(trimethylene carbonate), and poly(p-dioxanone), polydopamine, polypyrrole, polyaniline, polythiophene and combinations thereof and (b) the inorganic nanostructure is made from a material selected from a group consisting of carbon nanomaterials including carbon nanotubes, graphene, clay-based nanostructures including halloysite nanotubes, nanoparticles composed of transition and or noble metals, and combinations thereof.
16. The photothermal polymeric aerogel of item 1, wherein an outer surface of the nanostructure is hydroxylated prior to bonding with the polymer.
17. The photothermal polymeric aerogel of item 1, wherein an outer surface of the nanostructure is carboxylated prior to bonding with the polymer.
18. The photothermal polymeric aerogel of item 1, wherein an outer surface of the nanostructure is oxidated prior to bonding with the polymer.
19. The photothermal polymeric aerogel of item 1, wherein an outer surface of the nanostructure is aminated/amidated prior to bonding with the polymer.
20. The photothermal polymeric aerogel of item 1, wherein one or more ligand shells are conjugated on the surface of nanostructures.
21. The photothermal polymeric aerogel of item 1, wherein nanoparticles are functionalized through a hybrid coating process involving encapsulation within a previously functionalized silica shell.
22. A photothermal polymeric aerogel comprising: an inorganic nanostructure having a functionalized outer surface; and a polymer bound to the nanostructure.
23. A photothermal polymeric aerogel, comprising:
   a functionalized inorganic nanostructure; and
   a polymer bound to the nanostructure.
24. The photothermal polymeric aerogel of item 23, wherein the polymer is a polysaccharide.
25. The photothermal polymeric aerogel of item 23, wherein hydroxyl, carboxyl, and/or amino groups of polymers are physically and chemically modified to regulate the hydrophilicity/hydrophobicity of the aerogels.
26. The photothermal polymeric aerogel of item 23, wherein hydrophobic segments are saturated or unsaturated hydrocarbons including linear, branched, cyclic, and/or aromatic groups.
27. The photothermal polymeric aerogel of item 23, wherein the polymer may be grafted to or cross-linked with other biocompatible synthetic molecules, monomers, oligomers, and polymers such as polylactides, polyglycolide, poly(8-caprolactone), poly(trimethylene carbonate), and poly(p-dioxanone).
28. A method of treating wastewater to remove toxic metals, comprising contacting the wastewater with a photothermal polymeric aerogel as set forth in any of items 1-27.
29. A method of making a photothermal polymeric aerogel, comprising:
   functionalizing an outer surface of a nanostructure; and binding a modified polymer to the nanostructure.
30. The method of item 29, wherein the functionalizing includes carboxylating the outer surface.
31. The method of item 29, wherein the functionalizing includes hydroxylating the outer surface.
32. The method of item 29, wherein the functionalizing includes oxidization of the outer surface.
33. The method of item 29, wherein the functionalizing includes amidation/amination of the outer surface.
34. The method of item 29, wherein the functionalizing includes conjugation of one or more ligand shells on the surface of nanostructures.
35. The method of item 29, wherein the functionalizing includes a hybrid coating process involving encapsulation of nanoparticles within a previously functionalized silica shell.
36. The method of item 29, wherein the functionalizing includes hydrophilic/hydrophobic regulation of polymer backbone.
37. The method of item 29, wherein the functionalizing includes grafting/crosslinking of a photothermal polymer to polysaccharides.
38. The method of item 29, wherein the functionalizing includes copolymerization of the modified polymer with a synthetic biodegradable monomer, oligomer, and/or polymer.
39. The method of item 29, further including binding the modified polymer to the functionalized outer surface of the nanostructure.
40. The method of item 29, wherein a functional hybrid organic/inorganic structure is converted to aerogel through freeze-drying, or supercritical fluid, or ambient pressure techniques.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a polymer”, as used herein, may also refer to, and encompass, a plurality of polymers.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10 % of the stated numerical value.

Although the photothermal polymeric aerogels of this disclosure, and their methods of production as well as use or application, have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

1. A photothermal polymeric aerogel, comprising:
an inorganic nanostructure; and
a polymer bound to the nanostructure.

2. The photothermal polymeric aerogel of item 1, wherein the polymer is a natural polymer.

3. The photothermal polymeric aerogel of item 2, wherein the polymer is a polysaccharide.

4. The photothermal polymeric aerogel of item 2, wherein the polymer is selected from a group of polymers consisting of chitosan, chitin, cellulose, carboxylated cellulose, hydroxyalkyl cellulose, alginates, alginic acid, guar gum, dextrin, pectin, and combinations thereof.

5. The photothermal polymeric aerogel of item 1, wherein the polymer is selected from a group of a polysaccharide, a polymer with photothermal properties, and combinations thereof.

6. The photothermal polymeric aerogel of item 5, wherein the polymer with photothermal properties may be selected from polydopamine and conjugated polymers including polypyrrole, polyaniline, polythiophene, and combinations thereof.

7. The photothermal polymeric aerogel of item 1, wherein the inorganic nanostructure is a carbonaceous nanostructure.

8. The photothermal polymeric aerogel of item 1, wherein the inorganic nanostructure is a clay-based nanostructure.

9. The photothermal polymeric aerogel of item 1, wherein the inorganic nanostructure is a metal nanoparticle selected from transition and/or noble metals.

10. The photothermal polymeric aerogel of item 1, wherein the inorganic nanostructure is made from a material selected from a group consisting of carbon nanotubes, graphene, halloysite nanotubes and combinations thereof.

11. The photothermal polymeric aerogel of item 1, wherein the polymer is polymerized to the nanostructure.

12. The photothermal polymeric aerogel of item 1, wherein the inorganic nanostructures may be physically incorporated into the polymers via processes induced by Van der Waals forces, dipolar interactions or weak hydrogen bonding.

13. The photothermal polymeric aerogel of item 1, wherein the polysaccharide is cross linked to the nanostructure with a cross-linking agent.

14. The photothermal polymeric aerogel of item 16, wherein the cross-linking agent is selected from a group consisting of a multivalent ionic cross-linker including Ca²⁺ and Fe³⁺ complexes, a carboxylic acid, an inorganic acid, an amide, a glutaraldehyde, an epoxy compound, an isocyanate and combinations thereof.

15. The photothermal polymeric aerogel of item 1, wherein (a) the polymer is selected from a group of polymers consisting of chitosan, chitin, cellulose, carboxylated cellulose, hydroxyalkyl cellulose, an alginate, alginic acid, guar gum, dextrin, pectin, a polylactide, polyglycolide, poly(8-caprolactone), poly(trimethylene carbonate), and poly(p-dioxanone), polydopamine, polypyrrole, polyaniline, polythiophene and combinations thereof and (b) the inorganic nanostructure is made from a material selected from a group consisting of carbon nanomaterials including carbon nanotubes, graphene, clay-based nanostructures including halloysite nanotubes, nanoparticles composed of transition and or noble metals, and combinations thereof.

16. The photothermal polymeric aerogel of item 1, wherein an outer surface of the nanostructure is hydroxylated prior to bonding with the polymer.

17. The photothermal polymeric aerogel of item 1, wherein an outer surface of the nanostructure is carboxylated prior to bonding with the polymer.

18. The photothermal polymeric aerogel of item 1, wherein an outer surface of the nanostructure is oxidated prior to bonding with the polymer.

19. The photothermal polymeric aerogel of item 1, wherein an outer surface of the nanostructure is aminated/amidated prior to bonding with the polymer.

20. The photothermal polymeric aerogel of item 1, wherein one or more ligand shells are conjugated on the surface of nanostructures.

21-40. (canceled)
